(19) United States
(12) Patent Application Publication
(10) Pub. No.: US 2017/0267388 A1
(43) Pub. Date: Sep. 21, 2017

(54) FOOD AND LABELING APPARATUS

(71) Applicant: Iconex LLC, Duluth, GA (US)

(72) Inventors: Jeffrey Alton Whitford, Richmond, KY (US); Austin Daniel Anderson, Dacula, GA (US)

(21) Appl. No.: 15/074,449

(22) Filed: Mar. 18, 2016

(51) Int. Cl. B65C 1/02; B65C 9/40

(52) U.S. Cl. CPC B65C 1/02; B65C 9/40

(57) ABSTRACT

A food and label apparatus is provided including a food assembly apparatus and a labeling apparatus coupled to the food assembly apparatus. The labeling apparatus configured for holding a label corresponding to a food order and the food assembly apparatus for assembling food corresponding to the food order.

### BACKGROUND

Food service that is not pre-made but custom made to order presents a variety of challenges to ensure food safety and order accuracy. A technique employed by several beverage and fast food establishments is to print a label identifying the order and the details of the order. The label is then affixed to the food packaging or beverage container and passed to one or more servers for processing the food or beverage order.

For some food service establishments this label to packaging technique is challenging. For example, tacos are not built or assembled on a wrap to which a label is affixed or any consumable product (such as a carton or container); rather, tacos are built independent of the wraps or box containers, which are used after the tacos are assembled. Therefore, once the taco is built, wrapped, and finally a label applied, the worker can forget what was put into the taco or even what kind of taco it was.

Moreover, labels carried with a taco order can end up being dropped to the floor in the taco building process or even end up inadvertently in the taco itself. Therefore, during busy traffic, the workers rely on overhead monitors and do not attempt to carry labels with the taco building processing. But, workers can be handling several orders at once and one order after another and continually looking up at the monitors and down at the food station creates errors in orders.

This situation is not strictly limited to taco preparation but can also occur in non-fast food restaurants that make custom-order dishes for consumers.

Therefore, what is needed is techniques, apparatuses, and systems for permitting custom-food assembly to carry order labels with the food as it is being assembled for improved accuracy and without impacting food safety or order timeliness.

### SUMMARY

In various embodiments, a food and labeling apparatus, a food and labeling system, and a method for food assembling and labeling are presented.

According to an embodiment, a food and labeling apparatus is provided. Specifically, a food and labeling apparatus includes a food assembly apparatus and a labeling apparatus coupled to the food assembly apparatus, wherein the labeling apparatus further includes a surface for holding labels during food assembly on the food assembly apparatus.

### BRIEF DESCRIPTION OF THE DRAWINGS

FIG. 1A is a diagram a food and labeling apparatus, according to an example embodiment.

FIG. 1B is another diagram of a food and labeling apparatus, according to an example embodiment.

FIG. 1C is a diagram of a component of the food and labeling apparatus from the FIGS. 1A-1B, according to an example embodiment.

FIG. 2 is a diagram of a food and labeling system, according to an example embodiment.

FIG. 3 is a diagram of a method for food assembling and labeling, according to an embodiment.

### DETAILED DESCRIPTION

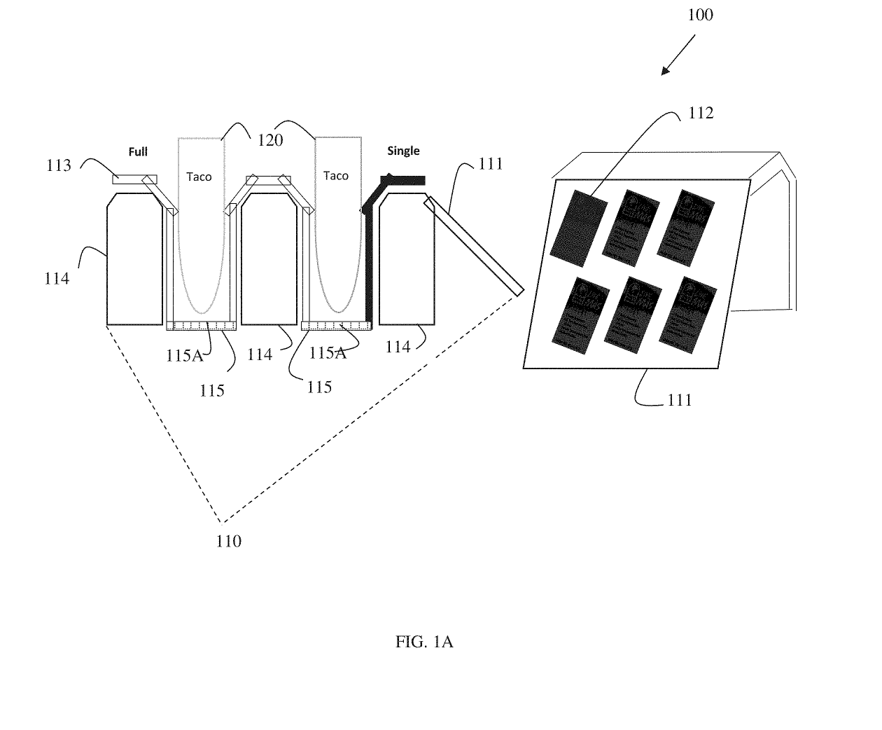

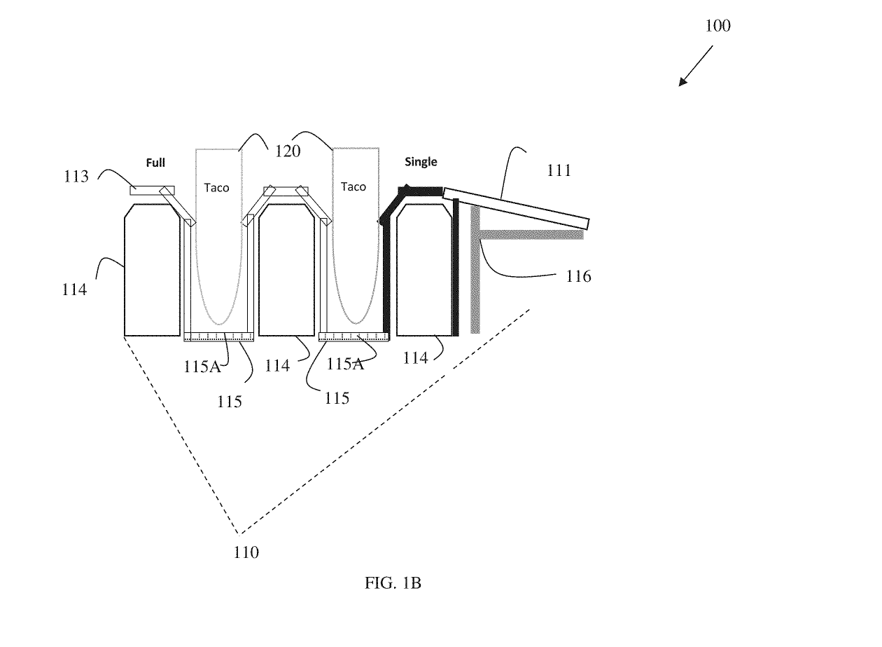

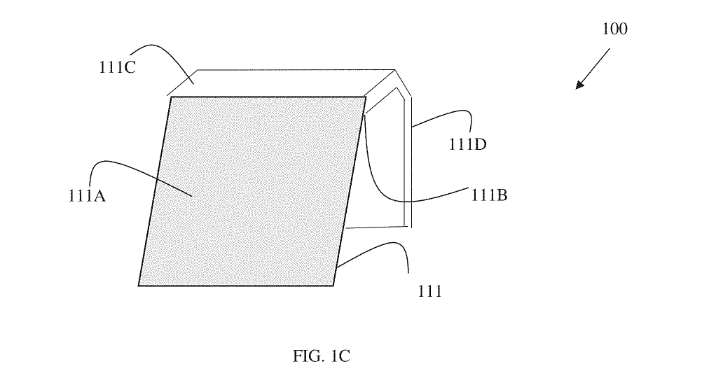

FIG. 1A is a diagram a food and labeling apparatus 110, according to an example embodiment. In the example embodiment, the food labeling apparatus 110 is configured for taco/burrito assembly and labeling. It is noted that other configurations for other food service assembly can be used without departing from the teachings presented herein.

The food labeling apparatus 110 (shown from a side view on the left-hand side of the FIG. 1A) includes a rail apparatus 113 with posts 114, and bases 115 at troughs of the rail apparatus 113. The food labeling apparatus also includes a labeling apparatus 111 (shown from a front view perspective on the right-hand side of the FIG. 1A). In an embodiment the rail apparatus 113 includes a weighted base (near or in proximity to where 113 is pointing to in the FIG. 1A to provide stability to the rail apparatus 113 and prevent tipping with the labeling apparatus 111).

In the example configuration of the food labeling apparatus 110, the troughs are designed to have a height and width to support holding a food product, such as tacos 120 shown in the FIG. 1A.

In an embodiment, the food labeling apparatus 110 is made of a stainless steel or plastic material, which is washable.

The bases 115 include slits or holes 115A that permit food that slips between the tacos 120 and the bases 115 to fall through the food labeling apparatus 110 and into a catch basin or onto a counter during food assembly. In an embodiment, the catch basin is included as an attachment to the food labeling apparatus 110 under the bases 115, such that the catch basin can be removed and emptied and reattached back to the bases. In an embodiment, the bases 115 are weighted to prevent tipping the food and labeling apparatus 110.

In an embodiment, the food labeling apparatus 110 is a zigzag tray configuration to hold tacos 120 upright and assemble or build multiple tacos at once.

It is to be noted that although the depicted food labeling apparatus 110 of the FIG. 1A includes troughs for up to four tacos (the side view depicted in the FIG. 1 A does not fully render the length of the trough for holding two tacos within the a single trough, such that four tacos may be handled simultaneously with the food labeling apparatus 110), the food labeling apparatus 110 is not to be so limited and can include more than two slots for more than four taco assemblies.

The food labeling apparatus 110 is adapted to be slid down a food counter for food assembly.

In an embodiment, the bottom surface of the food labeling apparatus 110 that contacts the food counter is made of a material to reduce friction and permit the food labeling apparatus 110 to easily glide along the food counter surface.

The food labeling apparatus 110 also includes a labeling apparatus 111. A front view of the labeling apparatus 111 is shown on the right-hand side of the FIG. 1A and again in the FIG. 10 (below).

The view of the FIG. 1A is from a side view of the food labeling apparatus 110 to illustrate the angled orientation of the labeling apparatus 111. The labeling apparatus 111 is angled and faces the food service technician during food assembly. The surface of the labeling apparatus 111 is coated with a non-stick coating to which labels 112 can be applied. The labels 112 correspond to specific food orders of customers being assembled or built with the food labeling apparatus 110 as the food labeling apparatus 110 is slid down the food counter from worker to worker involved in the order assembly. This permits the food service technician to be looking at the food and the labeling apparatus having the order details on the labels 112 while the food is being assembled on the food labeling apparatus 110. When the food assembly is complete a wrapper or packaging is obtained and wrapped or packaged and the label is peeled off the non-stick surface of the labeling apparatus 111 and affixed to the wrapping or packaging.

In an embodiment, the angle of the labeling apparatus 111 with respect to the surface of the counter to which the food labeling apparatus 110 is slid along is adjustable, such that each food service technician can adjust the viewing angle of the labeling apparatus 111 to an angle that is most convenient for that particular technician based on that technician's height and/or work habits.

FIG. 1B is another diagram of a food and labeling apparatus, according to an example embodiment.

In the FIG. 1 B, the labeling apparatus 111 has an angle that is approximately or nearly 90 degrees with respect to the horizontal. To support this an added base structure 116 is added to the labeling apparatus 111. The base structure 116 adds support to the angled surface of the labeling apparatus 111 and to the food and labeling apparatus 110 preventing tipping while food is being assembled in the food and labeling apparatus and the labels adhered and removed from the angled surface of the labeling apparatus 111.

FIG. 1C is a diagram of a component 111 of the food and labeling apparatus 110 from the FIG. 1A. according to an example embodiment.

FIG. 1C shows another front view of the labeling apparatus 111 from the food and labeling apparatus 111.

The labeling apparatus includes a non-stick coating 111A on its front-facing surface (the surface to which food labels for food orders are affixed). The labeling apparatus 111 includes a top 111C, which is parallel to a surface to which the food and labeling apparatus 110 glides along (such as a food counter), a rear base 1110, and hinged angle 111C that couples the top 111C to the front-facing surface having the non-stick coating 111A.

In an embodiment, the non-stick coating 111A includes a silicon-based coating mixture.

In an embodiment, the non-stick coating 111A is washable.

In an embodiment, the non-stick coating 111A can be reapplied when it begins to wear off or lose its non-stick qualities.

In an embodiment, the hinged angle 110 can be user adjusted to a desired angle for viewing the food order labels 112.

In an embodiment, the labeling apparatus 111 is detachable from and re-attachable to the remaining components of the food and labeling apparatus 110.

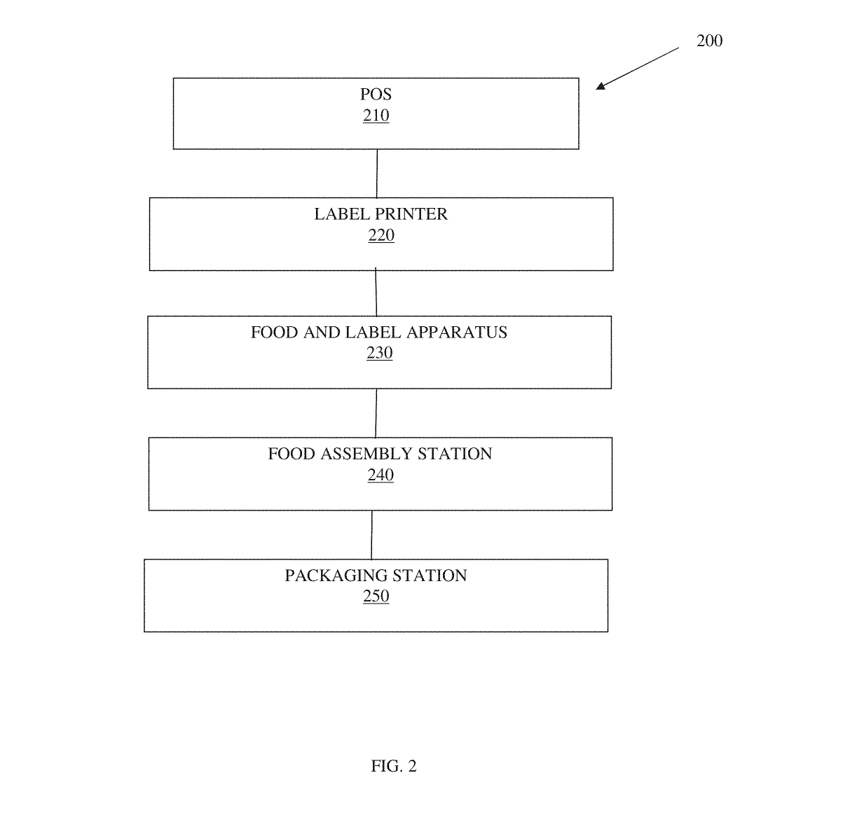

FIG. 2 is a diagram of a food and labeling system 200, according to an example embodiment

The food and labeling system 200 includes a Point-Of-Sale (POS) terminal 210, a label printer 220, a food and labeling apparatus 230, one or more food assembly stations 240, and a packaging station 250.

The POS terminal 210 is configured for taking a customer food order at a food service establishment and communicating the food order for label printing at the label printer 240.

When the label is printed from the label printer 220 it is removed and affixed to the labeling apparatus 111 of the food and labeling apparatus 230.

In an embodiment, the food and labeling apparatus 230 is the food and labeling apparatus 110 of the FIGS. 1A-1C.

The food and labeling apparatus 230 is then slid along a counter to the food assembly station 240. The food for the food order is assembled on the food and labeling apparatus 230 while a food technician views the food order label adhered to the angled and front facing surface of the labeling apparatus 111.

When the food assembly is completed for the food order, the food and labeling apparatus 230 is further slid along the food counter to a packaging station 250. At the packaging station 250, the food is removed from food and labeling apparatus 230 and wrapped or placed in packaging and the food order label is peeled from the labeling apparatus 111 and adhered to the wrapping or packaging.

Finally, the packaged food order with the label order is delivered to the customer who originally placed the order and the food and labeling apparatus 230 is returned back to a location near the label printer 220 for handling the next food order at the food service establishment.

The food and labeling apparatus 230 is washable and each food service establishment may include a plurality of food and labeling apparatuses 230 for handing appropriate food order traffic.

In an embodiment, the labeling apparatus 111 is configured to affix or support other types of kitchenware on which food is placed or assembled before delivery to a customer, such as and not limited to, a plate or a tray holding a plate.

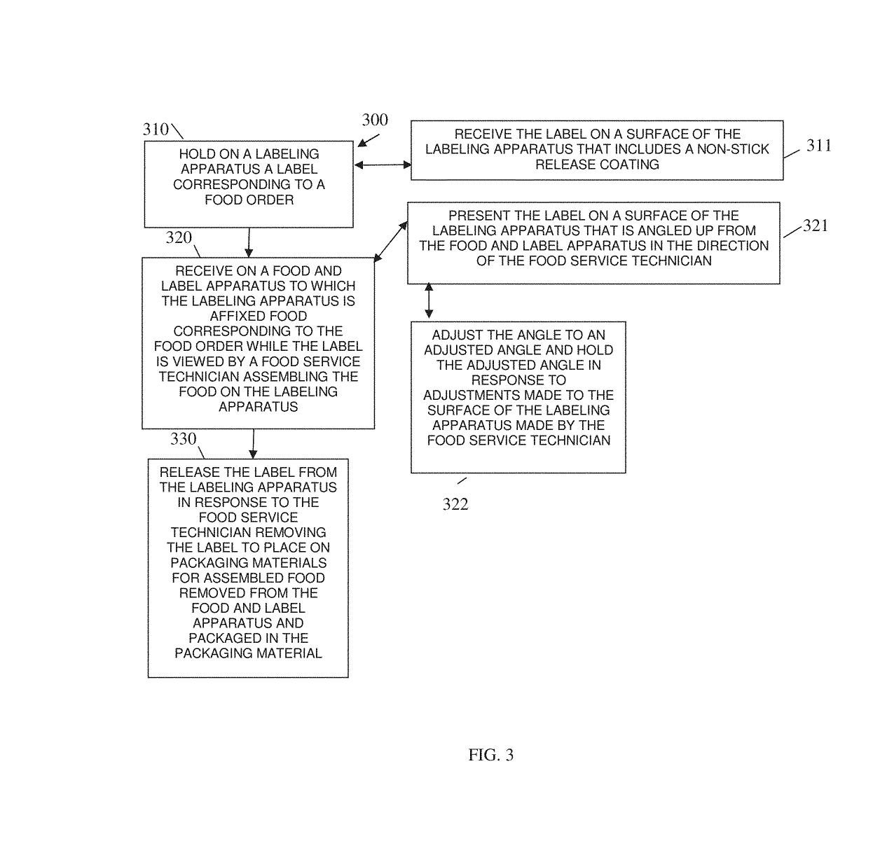

FIG. 3 is a diagram of a method 300 for food assembling and labeling, according to an embodiment.

At 310, a label corresponding to a food order is held on a labeling apparatus.

In an embodiment, the labeling apparatus is the labeling apparatus 111.

In an embodiment, at 311, the label is received on a surface of the labeling apparatus that includes a non-stick release coating. So, adhesive on the rear side of the label will hold on the surface but can be removed from the surface without impacting the adhesion qualities of the adhesive on the rear side of the label.

At 320, food is received on a food and label apparatus, which includes the labeling apparatus. The labeling apparatus affixed to or integrated within the food and label apparatus. The food corresponds to food order as dictated by information printed on the front-side of the label, and the front-side of the label viewable by a food service technician while assembling the food on the labeling apparatus.

In an embodiment, the food and label apparatus is the food and label apparatus 110.

In an embodiment, the food and label apparatus is the food and label apparatus 230.

According to an embodiment, at 321, the label is presented on a surface of the labeling apparatus that is angled up from the food and label apparatus in the direction of the food service technician.

In an embodiment of 321 and at 322, the angle is adjusted to an adjusted angle and the adjusted angle is held in place in response to adjustments made to the surface of the labeling apparatus by the food service technician.

In an embodiment, at 330, the label is released from the labeling apparatus in response to the food service technician removing the label to place on packaging materials for assembled food removed from the food and label apparatus and packaged in the packaging materials.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. An apparatus, comprising:
a food assembly apparatus; and
a labeling apparatus coupled to the food assembly apparatus, wherein the labeling apparatus further includes a surface for holding labels during food assembly on the food assembly apparatus.

2. The apparatus of claim 1, wherein the surface is angled upward for viewing by a food service technician during the food assembly.

3. The apparatus of the claim 2, wherein the surface is adjustable to a desired angle of the food service technician.

4. The apparatus of the claim 1, wherein the surface is coated with a non-stick release coating.

5. The apparatus of the claim 1, wherein the apparatus is adapted to be slid across a food service counter.

6. The apparatus of claim 1, wherein the food assembly apparatus includes a bottom having slits or holes through which food may fall through during the food assembly.

7. The apparatus of claim 6, wherein the food assembly apparatus further includes a catch basin under the bottom of the food assembly apparatus for catching the food falling through the slits or the holes of the bottom.

8. The apparatus of claim 7, wherein the catch basin is detachable from the bottom of the food assembly apparatus.

9. The apparatus of claim 1, wherein the apparatus is made of a washable material.

10. The apparatus of claim 1, wherein the labeling apparatus is detachable from the food assembly apparatus.

11. A system, comprising:
a label; and
a food and label apparatus including:
a food assembly apparatus; and
a labeling apparatus coupled to the food assembly apparatus and angled for viewing during food assembly on the food assembly apparatus, and wherein the labeling apparatus configured for holding the label corresponding to a food order relevant to the food assembly.

12. The system of claim 11 further including a label printer configured to print he label.

13. The system of claim 12 further including a Point-Of-Sale (POS) terminal configured to processing the food order and instructing the label printer to print the label.

14. The system of claim 11, wherein the food and label apparatus is further configured to be slid along a counter to a food assembly station.

15. The system of claim 14, wherein the food and label apparatus is further configured to be slid along the counter to a packaging station where food corresponding to completion of the food assembly is packaged and the label removed from the labeling apparatus and adhered to packaging for the food.

16. A method, comprising:
holding on a labeling apparatus a label corresponding to a food order; and
receiving on a food and label apparatus to which the labeling apparatus is affixed food corresponding to the food order while the label is viewed by a food service technician assembling the food on the labeling apparatus.

17. The method of claim 16, wherein holding further includes receiving the label on a surface of the labeling apparatus that includes a non-stick release coating.

18. The method of claim 16, wherein receiving further includes presenting the label on a surface of the labeling apparatus that is angled up from the food and label apparatus in the direction of the food service technician.

19. The method of claim 18, wherein presenting further includes adjusting the angle to an adjusted angle and holding the adjusted angle in response to adjustments made to the surface of the labeling apparatus made by the food service technician.

20. The method of claim 16 further comprising, releasing the label from the labeling apparatus in response to the food service technician removing the label to place on packaging materials for assembled food removed from the food and label apparatus and packaged in the packaging material.
